(19) United States
(12) Patent Application Publication
(10) Pub. No.: US 2023/0417692 A1
(43) Pub. Date: Dec. 28, 2023

(54) DETECTION METHOD AND DETECTION DEVICE

(71) Applicant: Shimadzu Corporation, Kyoto-shi (JP)

(72) Inventor: Takashi NYU, Kyoto-shi (JP)

(21) Appl. No.: 18/143,992

(22) Filed: May 5, 2023

(30) Foreign Application Priority Data
Jun. 22, 2022 (JP) 2022-100132

(51) Int. Cl. G01N 23/223

(52) U.S. Cl. CPC G01N 23/223; G01N 2223/33

(57) ABSTRACT

A detection method and a detection device capable of increasing position resolution when detecting a characteristic value distributed in a plane of a sample are provided. The detection method is configured to detect the characteristic value distributed in the plane of the sample by scanning the sample for each analysis area. The detection method includes the steps of: detecting the characteristic value of the sample a plurality of times while moving the analysis area in the plane of the sample so that the partial region of the analysis area overlaps; and calculating the characteristic value distributed in the plane of the sample in a unit of an overlapping region by performing statistical processing on detection results including the same region.

### CROSS-REFERENCE TO RELATED APPLICATIONS

This application claims priority under 35 U.S.C. § 119 to Japanese Patent Application No. 2022-100132 filed on Jun. 22, 2022, the entire disclosure of which is incorporated herein by reference in its entirety.

### BACKGROUND OF THE INVENTION

### Field of the Invention

The present disclosure relates to a detection method and a detection device for detecting a characteristic value distributed in a plane of a sample by scanning the sample for each scanning area

### Description of the Related Art

As one example of a device for performing an element analysis, an X-ray fluorescence analyzer is known. In an X-ray fluorescence analyzer, an analysis of elements contained in a sample is performed by detecting the fluorescence X-rays incident on a detector among fluorescence X-rays generated from a range of the sample irradiated with primary fluorescence X-rays. Therefore, in the X-ray fluorescence analyzer, the generation range of fluorescence X-rays that have arrived the detector out of the range irradiated with the the primary X-rays is an analysis area, and the average information on the element content within the analysis area can be acquired.

In the X-ray fluorescence analyzer, in the case of detecting the in-plane distribution of an element content contained in a sample, it is required to change the range of the primary X-rays emitted to the sample by using a capillary and scan the sample for each scanning area within the plane of the sample. Specifically, International Publication WO 2020/084890 discloses an X-ray analyzer that changes the primary X-rays irradiation range by using a capillary.

### SUMMARY OF THE INVENTION

However, the position resolution of the in-plane distribution of an element content included in a sample is determined by the primary X-ray irradiation range to the sample and the generation range of the fluorescence X-rays incident on the detector. Therefore, in order to improve the position resolution, it is required to narrow the primary X-ray irradiation range to the sample or reduce the size of the detector itself. In order to narrow the primary X-ray irradiation range, it was required to use a special capillary. Further, when the primary X-ray irradiation range is narrowed, the quantity of X-rays that can be detected by the detector is reduced, resulting in a longer detection time.

The present disclosure has been made to solve such a problem, and the object of the present disclosure is to provide a detection method and a detection device capable of increasing position resolution when detecting a characteristic value distributed in a plane of a sample.

A detection method according to the present disclosure is a detection method of detecting a characteristic value distributed in a plane of a sample by scanning the sample for each scanning area. The detection method includes the steps of:
detecting the characteristic value of the sample a plurality of times while moving the analysis area in the plane of the sample so that a partial region of the analysis area overlaps;
and performing statistical processing on detection results including the same region to calculate the characteristic value distributed in the plane of the sample in a unit of an overlapping region.

A detection device is a detection device for detecting a characteristic value distributed on a plane of a sample.

The detection device includes:
a detector configured to detect the characteristic value;
a moving mechanism configured to scan a sample for each analysis are of the sample;
a controller configured to control the detector and the moving mechanism; and
an operation unit configured to calculate the characteristic value distributed in the plane of the sample from detection results detected by the detector,
wherein the controller detects the characteristic value of the sample a plurality of times by the detector while moving the analysis area in the plane of the sample so that a partial region of the analysis area overlaps, and
wherein the operation unit performs statistical processing on the detection results including the same region, and calculates the characteristic value distributed in the plane of the sample in a unit of an overlapping region.

The above-described objects and other objects, features, aspects, and advantages of the present invention will become apparent from the following detailed descriptions of the present invention that can be understood with reference to the attached drawings.

### BRIEF DESCRIPTION OF THE DRAWINGS

The preferred embodiments of the present invention are shown by way of example, and not limitation, in the accompanying figures.

FIG. 1 is a schematic diagram of a detection device according to an embodiment.

FIG. 2 is a schematic diagram of another detection device according to an embodiment.

FIG. 3A is a schematic diagram for describing an analysis area of a sample.

FIG. 3B is a schematic diagram for describing an analysis area of a sample.

FIG. 4 is a flowchart showing a detection method according to an embodiment.

FIG. 5A is a schematic diagram showing detection results detected by a detection method according to an embodiment.

FIG. 5B is a schematic diagram showing detection results detected by a detection method according to an embodiment.

FIG. 6A is a schematic diagram for describing statistical processing of a detection method according to an embodiment.

FIG. 6B is a schematic diagram for describing statistical processing of a detection method according to an embodiment.

FIG. 7A is a schematic diagram for describing another statistical processing of a detection method according to an embodiment.

FIG. 7B is a schematic diagram for describing another statistical processing of a detection method according to an embodiment.

FIG. 8A is a schematic diagram for describing a scanning direction in an analysis area of a sample.

FIG. 8B is a schematic diagram for describing a scanning direction in an analysis area of a sample.

### DESCRIPTION OF THE PREFERRED EMBODIMENTS

In the following paragraphs, some preferred embodiments of the preset invention will be described by way of example and not limitation. It should be understood based on this disclosure that various other modifications can be made by those skilled in the art based on these illustrated embodiments.

Hereinafter, some embodiments will be described below with reference to the attached drawings. Note that in the drawings, the same or corresponding portion is assigned by the same reference symbol, and the description thereof will not be repeated.

### [Detection Device]

In this embodiment, a detection device for detecting a characteristic value distributed in a plane of a sample will be described below while exemplifying an X-ray fluorescence analyzer. Of course, the detection device is not limited to an X-ray fluorescence analyzer and may be any device capable of detecting a characteristic value distributed in a plane of a sample.

For example, as the inspection device, an X-ray apparatus, such as, e.g., an X-ray diffractometer (XRD), a fluorescence X-rays film thickness meter (XRF), an X-ray microscope (XRM), an X-ray electron spectrometer (XPS), an ultraviolet photoelectron spectrometer (UPS), and an X-ray absorption microstructure analysis (XAFS), a spectrometer, such as, e.g., a spectrophotometer (terahertz, infrared, near-infrared, ultraviolet-visible), a spectrofluorometer (RF), and a solid-state emission spectrometer (OES), and a microscope, such as, e.g., a fluorescence microscope (MFM), a scanning electron microscope (SEM), a transmission electron microscope (TEM), and an electron probe microanalyzer (EPMA), can be exemplified.

In the X-ray fluorescence analyzer, an analysis of elements contained in a sample is performed by detecting fluorescence X-rays incident on the detector among fluorescence X-rays generated from the primary fluorescence X-ray irradiation range of the sample. Therefore, the characteristic value to be detected by the detector in the X-ray fluorescence analyzer may be not only the fluorescent X-ray dose directly detected by the detector but also the element content calculated based on the detected fluorescent X-ray dose. Further, the characteristic value to be detected by the detector differs depending on the type of the detection device, and is the intensity of the light that has been separated in the case of a spectrometer, or the physical property based on the intensity of the light, and the electron that has been reflected or transmitted in the case of an electron microscope.

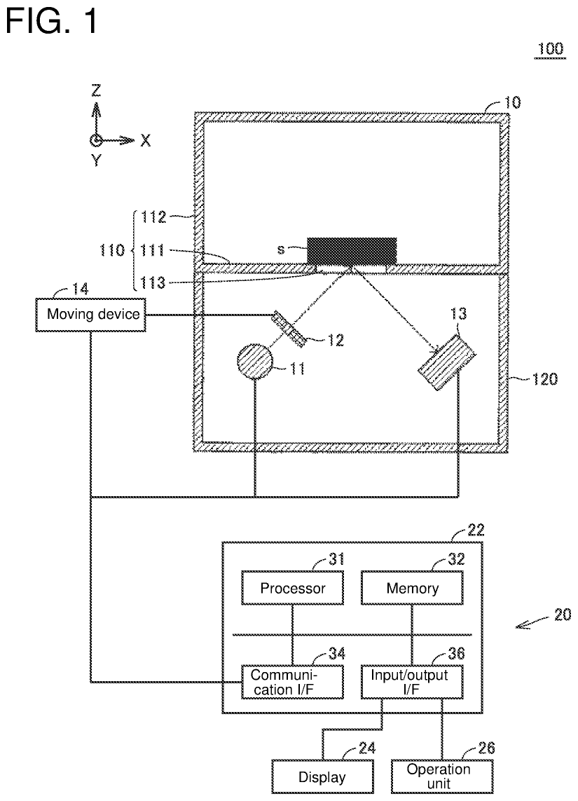

FIG. 1 is a schematic diagram of a detection device according to an embodiment. A detection device 100 has a device body 10 and a signal processing device 20. The detection device 100 is an energy dispersive X-ray fluorescence analyzer for analyzing contained elements of a sample by observing fluorescence X-rays generated from a sample “s” of an analysis target.

First, the device body 10 will be described. The device body 10 is provided with an analysis chamber 110 in which a sample “s” is arranged, and a device housing 120 in which an X-ray source 11, a collimator 12, and a detector 13 are arranged. The analysis chamber 110 includes a plate-shaped sample base 111 and a cylindrical upper chamber 112 having a plate-shaped upper surface. A circular opening 113 having, for example, a diametrical of 15 mm is formed in the central portion of the sample base 111. The upper chamber 112 is attached to the sample base 111 in an openable and closable manner by an analyst or the like. Note that in this specification, the plane on which the sample “s” is arranged is defined as an X-Y plane, and the direction perpendicular to the X-Y plane is defined as a Z-axis direction.

The X-ray source 11 is a point-focus X-ray tube and includes a housing in which, for example, a target serving as an anode and a filament serving as a cathode are arranged. The X-ray source 11 is fixed to the device housing 120 so that the X-rays emitted from the X-ray source 11 are incident within a predetermined illumination area. Therefore, by placing the sample “s” on the sample base 111 to block the opening 113, it is possible to irradiate the sample “s” in the predetermined irradiation area with X-rays.

The collimator 12 is arranged between the X-ray source 11 and the opening 113 as shown in FIG. 1. The collimator 12 is movable in a plane perpendicular to the optical axis of the X-rays by a moving device 14. By moving the collimator 12 with the moving device 14, the X-ray irradiation range can be moved within the plane of the sample “s.”

The detector 13 has, for example, a housing in which an introduction window is formed, and detection elements (semi-conductor elements) for detecting fluorescence X-rays are arranged inside the housing. The detector 13 is fixed to be located at the lower right of the opening 113 of the sample base 111, and is configured such that fluorescence X-rays generated by the sample “s” enter the introduction window.

The detector 13 can identify element contents (gray levels) identified by the intensity of the detected fluorescence X-rays. The detection device 100 can scan the sample for each analysis area that can be acquired from the detection result detected with the detector 13 in the plane of the sample “s” by moving the X-ray irradiation range by using the collimator 12 and can detect the in-plane distribution of the element content included in the sample “s.” In the detection device 100, the following description will be made such that the X-ray irradiation range corresponds to the analysis area of the sample “s.” However, it may be configured such that the entire surface of the sample “s” is irradiated with X-rays, and the sample “s” is scanned for each analysis area by moving the detectable range of the detector 13.

Next, the signal processing device 20 will be described. The detection signal corresponding to the fluorescence X-rays detected by the device body 10 is transmitted to the signal processing device 20. The signal processing device 20 has a controller 22, a display 24, and an operation unit 26. The signal processing device 20 controls the operation of the device body 10. Further, the signal processing device 20 analyzes the detection signal transmitted from the device body 10, and displays the result based on the analysis on the display 24 or stores the result in a memory 32.

The controller 22 is provided with, as its main components, a processor 31, a memory 32, a communication interface (I/F) 34, and an input/output I/F 36. These units are connected to each other via a bus in a mutually communicable manner.

The processor 31 is typically an arithmetic processing unit, such as, e.g., a CPU (Central Processing Unit) and an MPU (Micro Processing Unit). The processor 31 controls the operation of each unit of the detection device 100 by reading and executing a program stored in the memory 32. Specifically, the processor 31 executes the program to realize processing such as analyzing fluorescence X-rays data based on fluorescence X-rays detected by the detector 13. In the example shown in FIG. 1, a configuration is exemplified in which the processor is configured by a single processor, but the controller 22 may be configured to include a plurality of processors.

The memory 32 is realized by a non-volatile memory, such as, e.g., a RAM (Random Access Memory), a ROM (Read Only Memory), and a flash memory. The memory 32 stores programs to be performed by the processor 31 or data to be used by the processor 31.

The input/output I/F 36 is an interface for exchanging various types of data between the processor 31, the display 24, and the operation unit 26.

The communication I/F 34 is a communication interface for exchanging various types of signals and data with the device body 10, and is realized by an adaptor, a connector, or the like. The signal processing device 20 is connected to the X-ray source 11, the detector 13, and the moving device 14 via the communication I/F 34. The communication method may be a wired communication method or a wireless communication method such as a wireless LAN (Local Area Network).

To the controller 22, the display 24 and the operation unit 26 are connected. The display 24 is composed of a liquid crystal panel capable of displaying images. The operation unit 26 accepts a user's operation input to the detection device 100. The operation unit 26 is typically composed of a touch panel, a keyboard, a mouse, and the like.

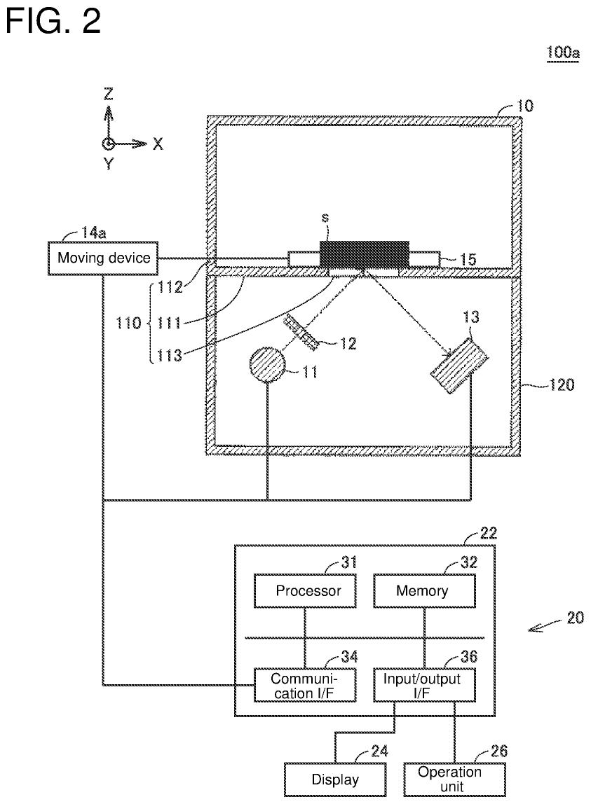

In the detection device 100, the analysis area can be moved within the plane of the sample “s” by moving the X-ray irradiation range in the plane of the sample “s.” However, the means for moving the X-ray irradiation range in the plane of the sample “s” can be realized by moving the sample “s” itself, in addition to by moving the collimator 12 described with reference to FIG. 1 by the moving device 14. FIG. 2 is a schematic diagram of another detection device 100a according to an embodiment. Note that in the detection device 100a shown in FIG. 2, the same component as that of the detection device 100 shown in FIG. 1 is assigned by the same reference symbol, and the detailed explanation thereof will be omitted.

In the detection device 100a shown in FIG. 2, a sample holder 15 on which a sample “s” is placed is provided. The sample holder 15 is movable within the X-Y plane of the sample base 111 by the moving device 14a. Therefore, in the detection device 100a, by moving the sample holder 15 with the moving device 14a, it is possible to move the part of the sample “s” that closes the opening 113 and move the X-ray irradiation range in the plane of the sample “s.” In the detection device 100a, the analysis area is moved within the plane of the sample “s” by moving the sample “s” itself.

### [Detection Method]

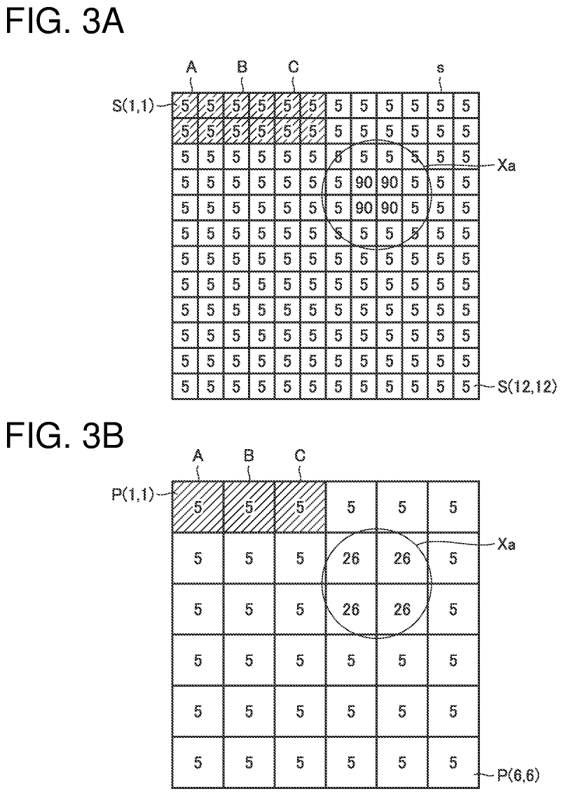

FIG. 3A and FIG. 3B are schematic diagrams for describing an analysis area of a sample “s.” FIG. 3A shows that a certain element content varies in the plane in the sample “s.” Specifically, in the range Xa, the element content is “90”, which is higher than that in the other ranges. Further, it is assumed that the element content of the sample “s” varies in the plane in a unit of 12×12 divided regions (S (1, 1) to S (12, 12)) as shown in FIG. 3A. Therefore, if the analysis area of the sample “s” is about the same as one of the regions divided into 12×12 regions, the detection device 100 can accurately detect the in-plane distribution of the element content contained in the sample “s.”

However, the X-ray irradiation range in the plane of the sample “s” is four regions out of the 12×12 divided regions as shown in FIG. 3A. In other words, the analysis area of the detector 13 is four regions. Therefore, the detection device 100 detects the in-plane distribution of the element content contained in the sample “s” by scanning the the sample for each analysis area from the region S (1, 1) to the region S (12, 12) of the sample “s” in a unit of four regions.

FIG. 3B shows the detection result of the in-plane distribution of the element content contained in the sample “s” obtained by scanning the the sample for each analysis area composed of four region units. The detection result of the range A shown in FIG. 3B is an average of the element contents of the four regions included in the range A shown in the corresponding FIG. 3A. Similarly, the detection results of the ranges B and C shown in FIG. 3B each are an average of the element contents of the four regions included in each of the ranges B and C shown in the corresponding FIG. 3A. That is, the detection device 100 can detect the in-plane distribution of the element content contained in the sample “s” in a unit of 6×6 divided ranges (P (1, 1) to P (6, 6)) as shown in FIG. 3B.

The detection device 100 can only obtain the detection result in a unit of 6×6 divided ranges as shown in FIG. 3B and detects the in-plane distribution of the element content contained in the sample “s” with a lower position resolution. For this reason, the detection device 100 cannot detect the in-plane distribution of the element content with high accuracy. In particular, the range in which the element content is “90” in the range Xa shown in FIG. 3A is as low as “26” in the detection result shown in FIG. 3B″, and the range in which the element content is higher than the other ranges is spreaded.

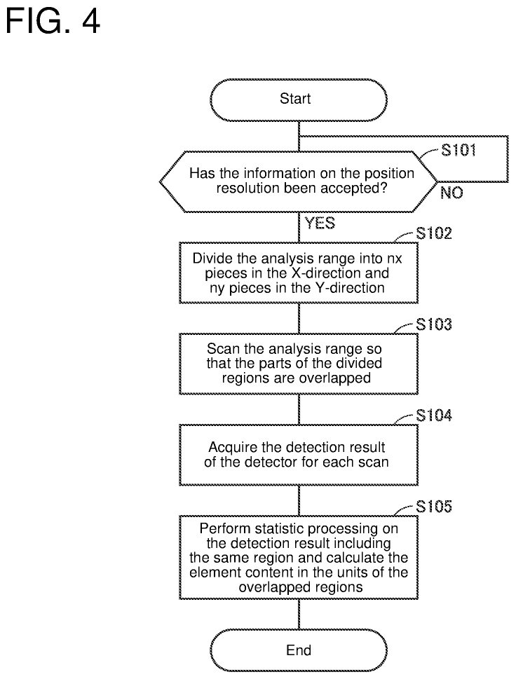

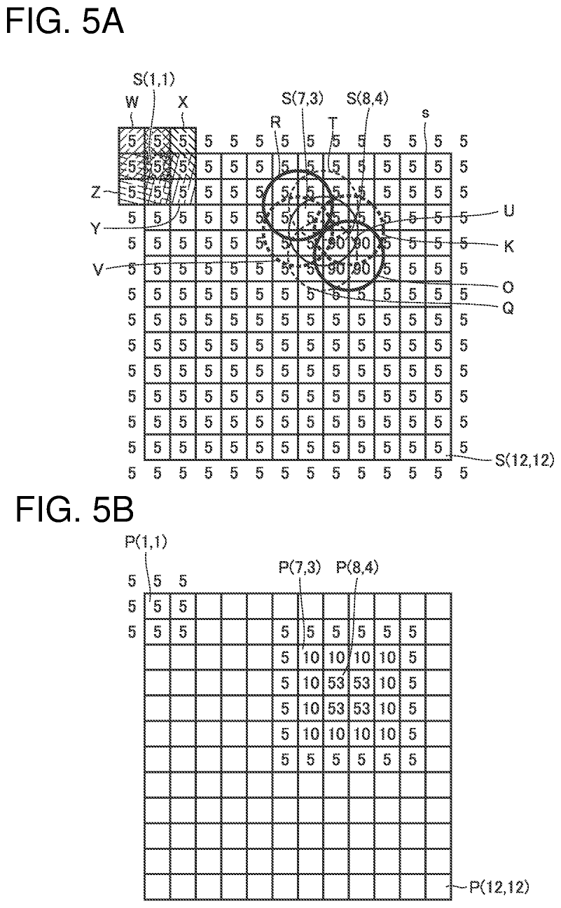

Therefore, in the detection device 100 according to this embodiment, in place of simply scanning the the sample for each analysis area composed of four region units, the element content of the sample “s” is detected a plurality of times while moving the analysis area in the plane of the sample “s” so that the partial region of the analysis area overlaps. FIG. 4 is a flowchart describing the detection method according to this embodiment. FIG. 5A and FIG. 5B are schematic diagrams showing the detection results detected by the detection method according to the embodiment.

First, the controller 22 determines whether information on the position resolution has been accepted (Step S101). Here, the number of dividing the analysis area into a plurality of regions is set as information on the position resolution. When accepted the information on the position resolution input by the user from the operation unit 26, the controller 22 divides the analysis area into “nx” pieces in the X-direction and “ny” pieces in the Y-direction, based on the information on the input position resolution (Step S102). Specifically, if the user sets such that, for example, the information on the position resolution is ¼ of the analysis area, the controller 22 divides the analysis area into four regions: nx=2 in the X direction and ny=2 in the Y direction, as shown in FIG. 5A and FIG. 5B. If the controller 22 has not accepted information on the position resolution (NO in Step S101), the controller 22 returns the processing to Step S101 and waits for the input of the information on the position resolution by the user from the operation unit 26. Of course, in a case where the controller 22 has not accepted the information on the position resolution (NO in Step S101), it may be configured to select the information on the predetermined position resolution (for example, ¼ of the analysis area).

In a case where the information on the input position resolution is ¼ of the analysis area, as shown in FIG. 5A and FIG. 5B, the controller 22 sets nx=2, and ny=2, and acquires the element content for each of four regions in which the analysis area of the sample “s” is divided into two in the X-direction and two in the Y-direction. Further, in a case where the information on the inputted position resolution is 1/9 of the analysis area, the controller 22 sets nx=3 and ny=3, and divides the analysis area of the sample “s” into three in the X-direction and three in the Y-direction, and acquires the element content for each of the nine regions. Furthermore, in a case where the information on the inputted position resolution is ⅓ of the analysis area, the controller 22 sets nx=1 and ny=2, divides the analysis area of the sample “s” into one in the X-direction and two in the Y-direction, and acquires the element content for each of the two regions.

Next, the controller 22 scans the sample “s” for each analysis area of the sample “s” so that the partial region (for example, at least one region of the divided regions) of the analysis area overlaps (Step S103). Specifically, the controller 22 controls the moving device 14, 14a to move the collimator 12 or the sample holder 15 to move the X-ray irradiation range in the plane of the sample “s,” whereby the sample “s” can be scanned for each analysis area of the sample “s” in a unit of an overlapping region (e.g., a unit of one divided region).

As shown in FIG. 5A, when focusing on the region S (1, 1), the analysis area of the sample “s” is scanned four times so as to overlap on the range W including the region S (1, 1) at the lower right, the range X including the region S (1, 1) at the lower left, the range Y including the region S (1, 1) at the upper left, and the range Z including the region S (1, 1) at the upper right. For the other region S as well, the the sample “s” is scanned for each analysis area of the sample “s,” and the analysis area of the sample “s” is scanned up to the region S (12, 12). As shown in FIG. 5A, it is assumed that the sample “s” exists outside the detection target by at least one region.

The controller 22 acquires the detection result of the detector 13 every time the the sample “s” is scanned for each analysis area (Step S104). Specifically, since the element content of each region included in the range W is “5”, the detection result of the range W is “5.” Similarly, since the element content of each region included in the range X is “5”, the detection result of the range X is “5.” Since the element content of each region included in the range Y is “5”, the detection result of the range Y is “5.” Since the element content of each region included in the range Z is “5”, the detection result of the range Z is “5.” Note that the detector 13 can merely acquire the average information on the element content within the analysis area and cannot actually acquire the element content in each region.

The controller 22 performs the processing (statistical processing) of determining the average for the detection result including the same region and calculates the element content in a unit of an overlapping region (Step S105). Specifically, when focusing on the region S (1, 1), the controller 22 averages the detection result “5” in the range W, the detection result “5” in the range X, the detection result “5” in the range Y, and the detection result “5” in the range Z to calculate the detection result P (1, 1) corresponding to the region S (1, 1) by Formula 1.

P(1,1)=(W+X+Y+Z)/4=(5+5+5+5)/4=5 (Formula 1)

Similarly, when focusing on the region S (7, 3), since the element content of each region included in the range R is “5,” the detection result in the range R is “5,” and since the element content in each region included in the range T is “5”, the detection result in the range T is “5.” Since there are three regions in which the element content in each region included in the range U is “5” and one region in which the element content in each region included in the range U is “90,” the detection result in the range U is approximately “26.” Since the element content of each region included in the range V is “5,” the detection result in the range V is “5.”

In this embodiment, small points or less are rounded off to represent the element content in an integer. The controller 22 averages the detection result “5” in the range R, the detection result “5” in the range T, the detection result “26” in the range U, and the detection result “5” in the range V, and calculates the detection result P (7, 3) corresponding to the region S (7, 3) by Formula 2.

P(7,3)=(R+T+U+V)/4=(5+5+26+5)/4=about 10 (Formula 2)

Similarly, when focusing on the region S (8, 4), since there are three regions in which the element content of each region included in the range U is “5” and one region in which the element content of each region included in the range U is “90,” the detection result of the range U is about “26.” Since there are two regions in which the element content in each region included in the range K is “5,” and two regions in which the element content in each region included in the range K is “90,” the detection result of the range K is “48.” Since there are two regions in which the element content in the region included in the range Q is “90,” two regions in which the element content in the region included in the range Q, the detection result in the range Q is “48.”

The controller 22 averages the detection result “26” in the range U, the detection result “48” in the range K, the detection result “90” in the range O, and the detection result “48” in the range R, and calculates the detection result P (8, 4) corresponding to the region S (8, 4) by Formula 3.

P(8,4)=(U+K+0+Q)/4=(26+48+90+48)/4=about 53 (Formula 3)

The detection device 100 performs the detection method shown in FIG. 4. As a result, the element content is “53” higher than the detection result shown in FIG. 3B, as shown in the detection result shown in FIG. 5B. Further, the detection device 100 can acquire the detection result in a unit of 12×12 divided regions as in FIG. 5B, can detect the in-plane distribution of the element content included in the sample “s” with a higher position resolution, and can detect the in-plane distribution of the element content with high accuracy.

Note that the detection device 100 performs the detection method shown in FIG. 4, and therefore, the position resolution of the detection result shown in FIG. 5B is four times higher than the position resolution of the detection result shown in FIG. 3B.

### [Statistical Processing]

In FIG. 5B, it is described that the controller 22 acquires the average for the detection result including the same region and calculates the element content in a unit of an overlapping region. However, the statistical processing performed on the detection result including the same region is not limited to the processing for obtaining the average, and other statistical processing for obtaining the median, the mode, and the like may be used.

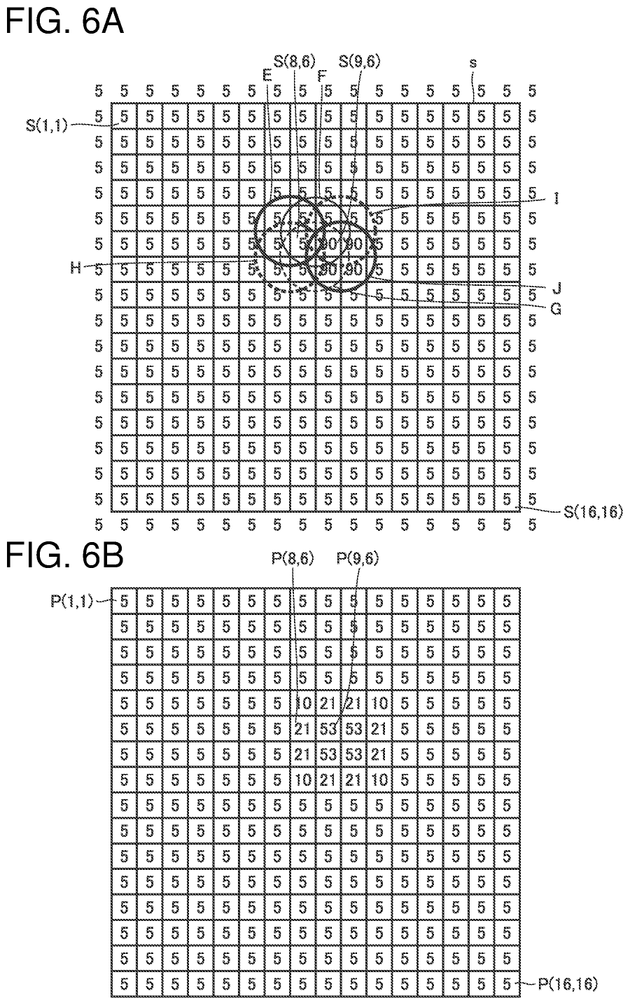

FIG. 6A and FIG. 6B are schematic diagrams for describing statistical processing of a detection method according to an embodiment. FIG. 6A shows a state in which a certain element content varies in the plane in the sample “s.” Specifically, the sample “s” varies in the element content in the plane in a unit of 16×16 divided regions (S (1,1) to S (16, 16)). In particular, in the region S (9, 6), the region S (9, 7), the region S (10, 6), the region S (10, 7), the element content is “90,” which is higher than in the other ranges.

For the sample “s” shown in FIG. 6A, the detection device 100 performs the detection method shown in FIG. 4 to obtain the average for the detection result including the same region, and the result obtained by calculating the element content in a unit of an overlapping region is shown in FIG. 6B.

In FIG. 6A, when focusing on the region S (8, 6), since the element content in each region included in the range E is “5,” the detection result in the range E is “5.” Since there are three regions in which the element content in each region included in the range F is “5,” and one region in which the element content in each region included in the range F is “90,” the detection result in the range F is approximately “26.” Since there are two regions in which the element content in each region included in the range G is “5,” and two regions in which the element content in each region included in the range G is “90,” the detection result in the range G is approximately “48.” Since the element content in the region included in the range H is “5,” the detection result in the range H is “5.”

The controller 22 averages the detection result “5” in the range E, the detection result “26” in the range F, the detection result “48” in the range G, and the detection result “5” in the range H, and calculates the detection result P (8, 6) corresponding to the region S (8, 6) by Formula 4.

P(8,6)=(E+F+G+H)/4=(5+26+48+5)/4=21 (Formula 4)

Similarly, when focusing on the region S (9, 6), since there are three regions in which the element content in each region included in the range F is “5,” and one region in which the element content in each region included in the range F is “90,” the detection result in the range F is approximately “26.” Since there are two regions in which the element content in each region included in the range G is “5,” and two regions in which the element content in each region included in the range G is “90,” the detection result in the range G is “48.” Since there are two regions in which the element content in each region included in the range I is “5,” and two regions in which the element content in each region included in the range I is “90,” the detection result in the range I is “48.” Since the element content in each region included in the range J is “90,” the detection result in the range J is “90.”

The controller 22 averages the detection result “26” in the range F, the detection result “48” in the range G, the detection result “48” in the range I, and the detection result “90” in the range J, and calculates the detection result P (9, 6) corresponding to the region S (9, 6) by Formula 5.

P(9,6)=(F+G+I+J)/4=(26+48+48+90)/4=about 53 (Formula 5)

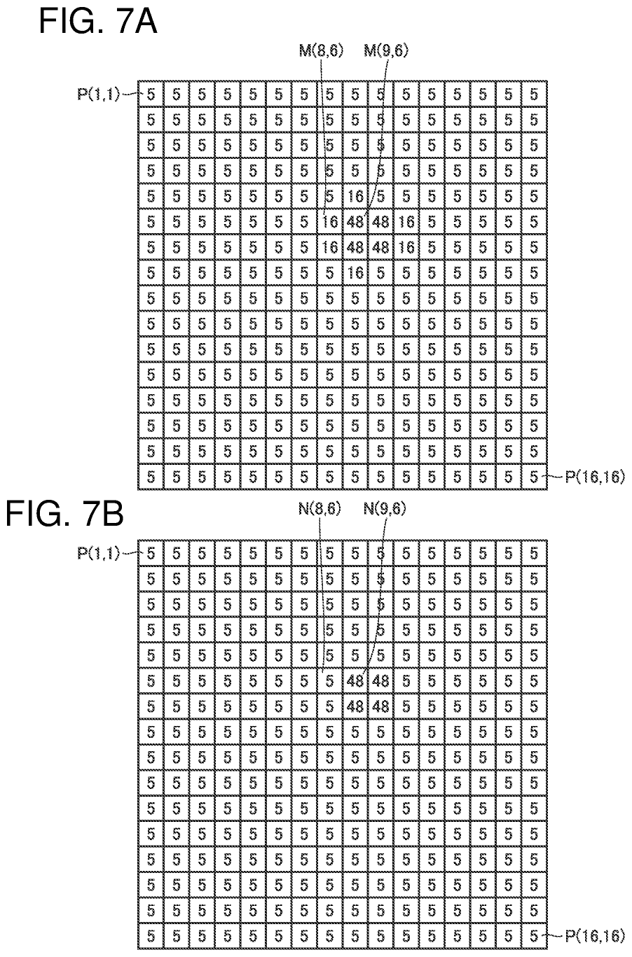

Next, FIG. 7A and FIG. 7B are schematic diagrams for describing another statistical processing of a detection method according to an embodiment. In FIG. 7A, the controller 22 obtains the median for the detection results including the same region for the sample “s” shown in FIG. 6A, and calculates the element content in a unit of an overlapping region.

Specifically, in FIG. 6A, when focusing on the region S (8, 6), the controller 22 obtains the median from the detection result “5” in the range E, the detection result “26” in the range F, the detection result “48” in the range G, and the detection result “5” in the range H, and calculates the detection result M (8, 6) corresponding to the region S (8, 6) by Formula 6.

M(8,6)=MEDIAN(E,F,G,H)=MEDIAN(5,26,48,5)=16 (Formula 6)

Similarly, when focusing on the region S (9, 6), the controller 22 obtains the median from the detection result “26” in the range F, the detection result “48” in the range G, the detection result “48” in the range I, and the detection result “90” in the range J, and calculates the detection result M (9, 6) corresponding to the region S (9, 6) by Formula 7.

M(9,6)=MEDIAN(F,G,I,J)=MEDIAN(26,48,48,90)=48 (Formula 7)

The detection device 100 obtains the median instead of the average as the statistical processing. Therefore, as compared with the detection result shown in FIG. 6B, the maximum value of the detection result shown in FIG. 7A is as small as “48.” However, the detection results shown in FIG. 7A are smaller in the range in which the element content is high as compared with the detection result shown in FIG. 6B.

Next, in FIG. 7B, the controller 22 obtains the mode for the detection results including the same region with respect to the sample “s” shown in FIG. 6A, and calculates the element content in a unit of an overlapping region.

Specifically, in FIG. 6A, when focusing on the region S (8, 6), the controller 22 obtains the mode from the detection result “5” in the range E, the detection result “26” in the range F, the detection result “48” in the range G, and the detection result “5” in the range H, and calculates the detection result N (8, 6) corresponding to the region S (8, 6) by Formula 8.

N(8,6)=MODE(E,F,G,H)=MODE(5,26,48,5)=5 (Formula 8)

Similarly, when focusing on the region S (9, 6), the controller 22 obtains the mode from the detection result “26” in the range F, the detection result “48” in the range G, the detection result “48” in the range I, and the detection result “90” in the range J, and calculates the detection result N (9, 6) corresponding to the region S (9, 6) by Formula 9.

N(9,6)=MODE(F,G,I,J)=MODE(26,48,48,90)=48 (Formula 9)

The detection device 100 obtains the mode instead of the average as the statistical processing. Therefore, as compared with the detection result shown in FIG. 6B, the maximum value of the detection result shown in FIG. 7B is as small as “48.” However, the detection result shown in FIG. 7B is narrower in the range in which the element content is high, as compared with the detection results shown in FIG. 6B and FIG. 7A. In the detection result shown in FIG. 7B, the range in which the element content is high coincides with that of the sample “s” shown in FIG. 6A, resulting in a high position resolution.

### [Scanning Direction]

In FIG. 5B, it was described that the controller 22 obtains the detection result four times for the same region, and calculates the element content in a unit of an overlapping region. However, for example, in a case where it is desired to know more about the in-plane distribution of the element content of the sample in one direction, it may be configured such that the analysis area of the sample “s” is divided to enhance the position resolution in the direction desired to know in detail, and the analysis area of the sample “s” is not divided in the other direction. With this, the number of times for obtaining the detection result can be reduced.

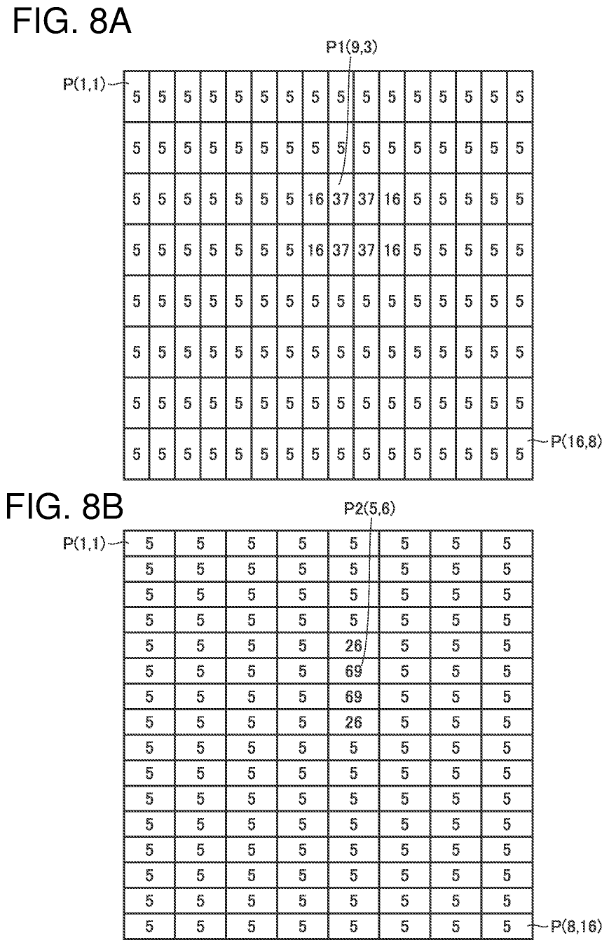

FIG. 8A and FIG. 8B are schematic diagrams for describing the direction of scanning a sample for each analysis area. FIG. 8A shows the result of the element content calculated by the method shown in FIG. 4 by dividing the sample “s” into each analysis area of the sample “s” in the X-direction (the left-right direction in the drawing) with respect to the sample “s” shown in FIG. 6A. That is, it is a case in which in Step S101 shown in FIG. 4, the number of dividing (nx=2, ny=1) of the analysis area of the sample “s” is accepted. In FIG. 8 A, the in-plane distribution of the element content included in the sample “s” is detected in a unit of 16×8 divided ranges (P (1, 1) to P (16, 8)).

Specifically, in FIG. 6A, when focusing on the region S (9, 5) and the region S (9, 6), the controller 22 averages the detection result “46” in the range F and the detection result “48 in the range I, and calculates the detection result P1 (9, 3) corresponding to the region S (9, 5) and the region S (9, 6) by Formula 10.

P1(9,3)=(F+I)/2=(26+48)/2=37 (Formula 10)

On the other hand, FIG. 8B shows the calculation result of the element content by the detection method shown in FIG. 4 by dividing the analysis area of the sample “s” in the Y-direction (the vertical direction in the drawing) with respect to the sample “s” shown in FIG. 6A. That is, it is the case in which in Step S101 shown in FIG. 4, the number of dividing the analysis area of the sample “s” (nx=1, ny=2) is accepted. In FIG. 8B, the in-plane distribution of the element content included in the sample “s” is detected in a unit of 8×16 divided ranges (P (1, 1) to P (8, 16)).

Specifically, in FIG. 6A, when focusing on the region S (9, 6) and the region S (10, 6), the controller 22 averages the detection result “48” in the range I and the detection result “90” in the range J, and calculates the detection result P2 (5, 6) corresponding to the region S (9, 6) and the region S (10, 6) by Formula 11.

P2(5,6)=(I+J)/2=(48+90)/2=69 (Formula 11)

In the examples shown in FIG. 8A and FIG. 8B, it is described that the number of times of the detection results to be obtained is reduced by reducing the number of divisions of the analysis area of the sample “s” to two (nx=2, ny=1) or (nx=1, ny=2). But, the number of detection results to be obtained may be reduced without reducing the number of divisions of the analysis area.

Specifically, the number of times of the detection results to be obtained may be reduced by performing the scanning in the Y-direction or the X-direction of the analysis area in a unit of two regions while keeping the number of dividing the analysis area of the sample “s” at four (nx=2, ny=2). That is, in a case where the analysis area is divided into n (two or more natural numbers) pieces of regions, the detection device 100 detects the characteristic value of the sample “s” a plurality of times so that the detection results including the same region are less than n pieces.

### [Aspects]

It is understood by those skilled in the art that the embodiments described above are specific examples of the following aspects.

### (Item 1)

A detection method according to one aspect of the present invention is a detection method of detecting a characteristic value distributed in a plane of a sample by scanning a sample for each analysis area. The detection method includes the steps of:
detecting the characteristic value of the sample a plurality of times while moving the analysis detecting the characteristic value of the sample a plurality of times while moving the analysis area in the plane of the sample so that a partial region of the analysis area overlaps; and
performing statistical processing on detection results including the same region to calculate the characteristic value distributed in the plane of the sample in a unit of an overlapping region.

According to the detection method as recited in the above-described Item 1, since the characteristic value of the sample is detected a plurality of times while moving the analysis area of the sample in the plane of the sample so that the partial region of the analysis area overlaps, and the statical processing is performed on the detection result including the same region, it is possible to increase the position resolution when detecting the characteristic value distributed in the plane of the sample.

### (Item 2)

The detection method as recited in the above-described Item 1, further includes the step of:
setting the number of dividing the analysis area into a plurality of regions as information on a position resolution.

According to the detection method as recited in the above-described Item 2, the number of dividing the analysis area into a plurality of regions can be set as the information on the position resolution, and therefore, the user can freely change the position resolution of the analysis area.

### (Item 3)

The detection method as recited in the above-described Item 1 or 2,
wherein the statistical processing is processing of determining any one of an average, a median, and a mode.

According to the detection method as recited in the above-described Item 3, it is possible to select appropriate processing from a plurality of statistical processing according to the type of the sample or the like.

### (Item 4)

The detection method as recited in any one of the above-described Items 1 to 3,
wherein when an overlapping partial region in the analysis area is defined as a region obtained by dividing the analysis area into “n” (two or more natural numbers) pieces, the statistical processing is performed on “n” pieces of the detection results including the same region to calculate the characteristic value.

According to the detection method as recited in the above-described Item 4, it is possible to increase the position resolution by n times when detecting the characteristic value distributed in the plane of the sample.

### (Item 5)

The detection method as recited in any one of the above-described Items 1 to 3,
wherein when an overlapping partial region of the analysis area is defined as a region obtained by dividing the analysis area into “n” (two or more natural numbers) pieces, the characteristic value of the sample is detected a plurality of times so that the detection results including the same region are less than “n” pieces.

According to the detection method as recited in the above-described Item 5, it is possible to shorten the detection time as compared with a case where the characteristic value of the sample is detected a plurality of times so that the number of the detection results including the same region becomes n.

### (Item 6)

The detection device according to one aspect of the present invention is a detection device for detecting a characteristic value distributed on a plane of a sample, including:
a detector configured to detect the characteristic value;
a moving mechanism configured to scan a sample for each analysis area;
a controller configured to control the detector and the moving mechanism; and
an operation unit configured to calculate the characteristic value distributed in the plane of the sample from detection results detected by the detector,
wherein the controller detects the characteristic value of the sample a plurality of times by the detector while moving the analysis area in the plane of the sample so that the partial region of the analysis area overlap, and
wherein the operation unit performs statistical processing on the detection results including the same region, and calculates the characteristic value distributed in the plane of the sample in a unit of an overlapping region.

According to the detection device as recited in the above-described Item 6, the characteristic value of the sample is detected a plurality of times while moving the analysis area in the plane of the sample so that a partial region of the analysis area overlaps. Therefore, it is possible to increase the position resolution in the case of detecting the characteristic value distributed in the plane of the sample.

### (Item 7)

The detection device as recited in the above-described Item 6,
wherein the controller sets the number of dividing the analysis area into a plurality of regions as information on a position resolution.

According to the detection device as recited in the above-described Item 7, the number of dividing the analysis area into a plurality of regions can be set as information on the position resolution. Therefore, the user can freely change the position resolution of the analysis area.

### (Item 8)

The detection device as recited in the above-described Item 6,
wherein the detection device is any one of an X-ray apparatus, a spectrometer, and a microscope.

According to the detection device as recited in the above-described Item 8, it is possible to increase the position resolution when detecting the characteristic value distributed in the plane of the sample in various devices.

Although some embodiments of the present invention have been described, the embodiments disclosed herein are to be considered in all respects as illustrative and not restrictive. The scope of the present invention is indicated by claims, and it is intended to include all modifications within the meanings and ranges equivalent to those of the claims.

1. A detection method of detecting a characteristic value distributed in a plane of a sample by scanning the sample for each analysis area, the detection method comprising the steps of:
detecting the characteristic value of the sample a plurality of times while moving the analysis area in the plane of the sample so that a partial region of the analysis area overlaps; and
performing statistical processing on detection results including the same region to calculate the characteristic value distributed in the plane of the sample in a unit of an overlapping region.

2. The detection method as recited in claim 1, further comprising the step of:
setting the number of dividing the analysis area into a plurality of regions as information on a position resolution.

3. The detection method as recited in claim 1,
wherein the statistical processing is processing of determining any one of an average, a median, and a mode.

4. The detection method as recited in claim 1,
wherein when an overlapping partial region in the analysis area is defined as a region obtained by dividing the analysis area into “n” (two or more natural numbers) pieces, the statistical processing is performed on “n” pieces of the detection results including the same region to calculate the characteristic value.

5. The detection method as recited in claim 1,
wherein when an overlapping partial region of the analysis area is defined as a region obtained by dividing the analysis area into “n” (two or more natural numbers) pieces, the characteristic value of the sample is detected a plurality of times so that the detection results including the same region are less than “n” pieces.

6. A detection device for detecting a characteristic value distributed in a plane of a sample, comprising:
a detector configured to detect the characteristic value;
a moving mechanism configured to scan the sample for each analysis area;
a controller configured to control the detector and the moving mechanism; and
an operation unit configured to calculate the characteristic value distributed in the plane of the sample from detection results detected by the detector,
wherein the controller detects the characteristic value of the sample a plurality of times by the detector while moving the analysis area in the plane of the sample so that a partial region of the analysis area overlaps, and
wherein the operation unit performs statistical processing on the detection results including the same region, and calculates the characteristic value distributed in the plane of the sample in a unit of an overlapping region.

7. The detection device as recited in claim 6,
wherein the controller sets the number of dividing the analysis area into a plurality of regions as information on a position resolution.

8. The detection device as recited in claim 6,
wherein the detection device is any one of an X-ray apparatus, a spectrometer, and a microscope.
